(19) United States
(12) Patent Application Publication
(10) Pub. No.: US 2018/0246980 A1
(43) Pub. Date: Aug. 30, 2018

(54) Uniform Resource Locator Link Generator

(71) Applicant: Invisible Friend LLC, Medina, MN (US)

(72) Inventors: Parisa Joy Hoveida, Minneapolis, MN (US); Gregory Peter Hladky, Minneapolis, MN (US)

(21) Appl. No.: 15/904,011

(22) Filed: Feb. 23, 2018

Related U.S. Application Data
(60) Provisional application No. 62/463,032, filed on Feb. 24, 2017.

(51) Int. Cl. G06F 17/30

(52) U.S. Cl. CPC G06F 17/30887; G06F 17/30882

(57) ABSTRACT

Using a link generator server to generate picture links. Picture links are selectable pictures that are linked to a website, a document, or a specific element within a document or other data. A picture link, when selected, directs the user to the particular website that it references. In some embodiments, a picture link provides a picture preview of information provided on the website to which the link references. For example, a picture link may be a picture of the website's logo or other information provided on the website. Accordingly, a picture link provides a user with information regarding the website to which it references.

### RELATED APPLICATION(S)

This patent application claims the benefit of U.S. Patent Application Ser. No. 62/463,032 filed on Feb. 24, 2017, the entirety of which is hereby incorporated by reference.

### BACKGROUND

A uniform resource locator (“URL”) is used to direct a computing device to a particular website. When individuals add a link to a URL into a document, email, website, or social media site, for example, such links are typically lengthy, blue, and non-descript. Furthermore, these links might not adequately capture the content to which the link directs the user.

### SUMMARY

Embodiments of the disclosure are directed to methods and systems implemented by a link generator server to generate picture links. In a first aspect, disclosed is a method for generating a picture link using a link generator server computer, the method comprising: obtaining, at the link generator server computer, a request to generate the picture link, wherein the request identifies a website; obtaining, by the link generator server computer, at least one image from the website; formatting, by the link generator server computer, the at least one image; and generating, by the link generator server computer, the picture link using an image from the at least one image.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### DESCRIPTION OF THE DRAWINGS

FIG. 1 shows an example system that can support the disclosed picture preview link generator.

FIG. 2 illustrates a block diagram representing example components of the link generator server shown in FIG. 1.

FIG. 3 illustrates an example user interface of the application for requesting the generation of a picture link.

FIG. 4 illustrates an edit user interface of the application for editing a picture link.

FIG. 5 illustrates an example user interface of the application for sharing the picture link.

FIG. 6 illustrates a method for generating a picture link, as performed by the link generator server.

FIG. 7 illustrates a method for requesting and editing a picture link, as performed by an application executing on the client device.

FIG. 8 illustrates example physical components of a server computer of the system of FIG. 1.

### DETAILED DESCRIPTION

The present disclosure is directed to systems and methods for generating picture links that, when selected, connect to a website, a document, or a specific element within a document or other data. In some embodiments, an application is used to generate the picture link, as will be described in further detail herein.

Picture links are selectable pictures that are linked to a website, a document, or a specific element within a document or other data. A picture link, when selected, directs the user to the particular website that it references.

In some embodiments, the disclosed picture links provide a picture preview of information provided on the website to which the link references. For example, a picture link may be a picture of the website's logo or other information provided on the website. Accordingly, a picture link provides a user with information regarding the website to which it references.

As will be described in further detail herein, aspects of this disclosure provide methods and systems for generating picture links that can be shared over any platform. For example, aspects of the present disclosure provide the ability to generate and share a picture link over email, over text message, in a website, in a social media website, in an instant messenger application, or even within a document.

Further aspects of the present disclosure provide the ability of a user to customize the picture link by selecting a particular picture from a plurality of pictures. Additionally, the user may add text over the picture link to provide further context or information about the link.

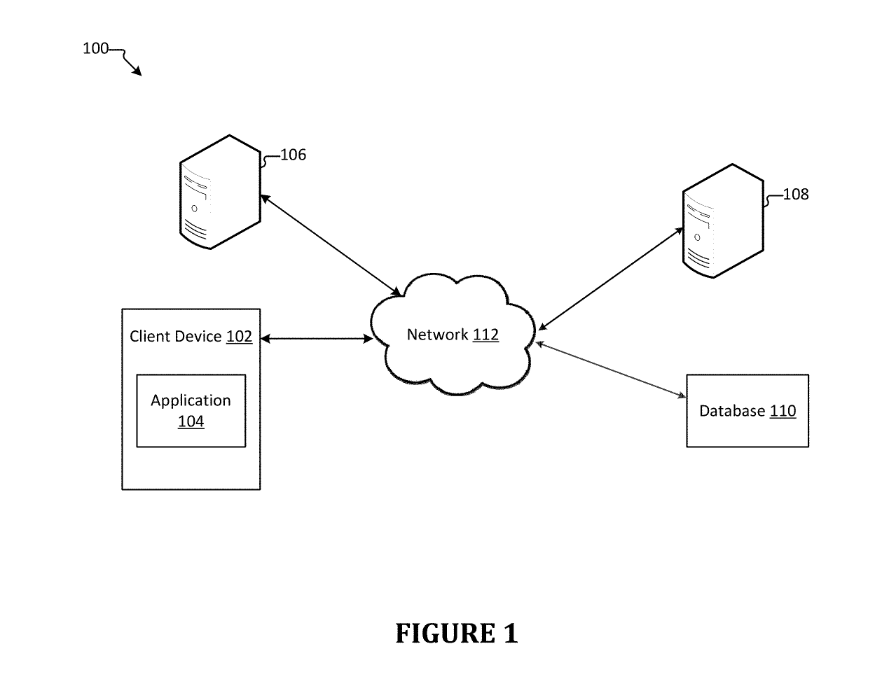

FIG. 1 shows an example system 100 that can support the disclosed picture link generator.

The example system 100 includes one or more client computing devices 102 executing an application 104, one or more third party servers 106, a link generator server 108, a database 110, and a communication network 112.

The example one or more client computing devices 102 may be personal or handheld computers having both input elements and output elements operated by one or more users. For example, the one or more client computing devices 102 may include one or more of: a mobile telephone, a smart phone, a tablet, a smart watch, a wearable computer, a personal computer, a desktop computer, a laptop computer, a gaming computer, a television, and the like. This list is exemplary only and should not be considered as limiting. Any suitable client computing device for generating a picture link may be used.

The one or more client computing devices 102 may execute thereon an application 104 for requesting, from the link generator server 108, the generation of a picture link. In some embodiments, the user operating the client computing device 102 may use the application 104 to identify a particular website that the picture link would reference.

Still further, the application 104 executing on the client computing device 102 may be used to edit a picture link generated by the link generator server 108. For example, a user may use the application 104 to select a different image or to add text to the picture link. The application 104 will be described in further detail herein.

The example one or more third party servers 106 may be a server computer hosted by a third party. In some embodiments, the third party server may host a website. In embodiments, a user operating one of the client computing devices 102 may request the generation of a picture link to a website hosted by one of the third party servers 106. In some embodiments, the third party servers 106 are hosted on multiple server computers.

In some embodiments, the link generator server 108 may be a server computer that generates a picture link. In some embodiments, the link generator server 108 may initially receive a request from a client computing device 102 to generate a picture link, wherein the request is generated by the application 104. In some embodiments, the request includes the identification of a URL to a particular website to which the picture link will be directed.

In some embodiments, the link generator server 108 communicates with a third party server 106 to obtain link information. In some embodiments, link information includes one or more images associated with a particular website to which the user wishes to reference in the picture link, wherein the website is hosted by the third party server 106.

In some examples, the link generator server 108 uses the link information obtained from the third party server 106 to generate a picture link. The link generator server 108 may automatically select an image from the one or more images provided in the link information to generate a picture image. Additionally or alternatively, the link generator server 108 may use an image selected by the user to generate the picture link. In some embodiments, the link generator server 108 uses image processing techniques to generate the picture link. In some embodiments, functionality performed by the link generator server 108 is distributed across one or multiple servers.

In some embodiments, the link generator server 108 stores the link information in a database 110. In some embodiments, the database 110 stores link information for each client. Additionally or alternatively, the database 110 stores link information for each referenced website. The database 110 may also store picture links generated by the link generator server 108.

In some aspects, network 112 is a computer network such as an enterprise intranet and/or the Internet. The example network 112 may include a Local Area Network (LAN), a Wide Area Network (WAN), the Internet, wireless and wired transmission mediums. In further aspects, server computing devices as described herein may communicate with some components of the system 100 via a local network (e.g., an enterprise intranet), whereas such server computing devices may communicate with other components of the system 100 via a wide area network (e.g., the Internet). In addition, the aspects and functionalities described herein may operate over distributed systems (e.g., cloud computing systems), where application functionality, memory, data storage and retrieval, and various processing functions may be operated remotely from each other over a distributed computing network, such as the Internet or an intranet.

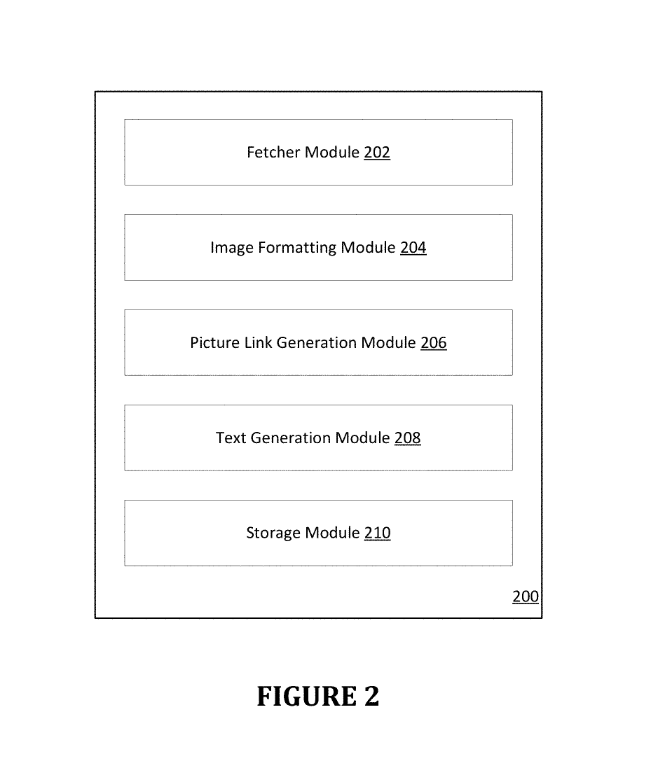

FIG. 2 illustrates a block diagram 200 representing example components of the link generator server 108 shown in FIG. 1.

In this example, the block diagram 200 includes a fetcher module 202, an image formatting module 204, a picture link generation module 206, a text generation module 208, and a storage module 210. Although specific modules are illustrated, more or fewer modules may further be included as necessary.

In some embodiments, the fetcher module 202 obtains one or more images associated with a website. In some embodiments, an image may be, for example, a logo of the website or one or more images found on the website. One or more of these images can be selected and downloaded automatically by the fetcher module 202.

In an example, the fetcher module 202 retrieves a destination address, or URL, from a request to create a picture link. As described herein, the request may be generated by the application 104 executing on a client computing device 102. In an example, the fetcher module 202 may parse the request to obtain the destination address.

In an example, the fetcher module 202 may request, from the third party server 106 that hosts the website identified in the request, the HTML content. After receiving the HTML content from the third party server 106, the fetcher module 202 may parse the HTML content to identify one or more image tags found therein. For each image tag, the fetcher module 202 may extract the corresponding image. The fetcher module may further obtain the HTML text of the website.

In some embodiments, the image formatting module 204 may inspect each extracted image to identify the image width, height, format, and color diversity. Based on such information, the image formatting module 204 may rank the images in order to create an order of priority. In some embodiments, higher the color diversity or the more pixelated the image will correspond to a higher image ranking.

In some embodiments, the picture link generation module 206 may create the picture link using an image of the one or more images obtained by the fetcher module 202. In some embodiments, the picture link generation module 206 automatically selects an image from the one or more images using, for example, based on the highest priority level. Alternatively or additionally, the picture link generation module 206 takes into consideration a user's settings in selecting an image (e.g., prioritizing a logo over a temporary image).

In some embodiments, machine learning methods may be implemented to determine a most representative image on a particular website. Training data to support machine learning may comprise user selection of pictures during an edit mode, as will be described in further detail herein. Accordingly, machine learning techniques may be employed to predict a particular user's behavior, or the behavior of multiple users.

In some embodiments, the picture link generation module 206 may crop each image or a subset of the images into a particular shape, such as, for example, a square or rectangular shape that can be used as the picture link. In some embodiments, the user may select the type of shape desired, and in other embodiments, the picture link generation module 206 automatically crops the picture based on, for example, the image itself to determine which shape would be ideal or preferable.

Furthermore, the picture link generation module 206 may also link the picture to the particular website. Accordingly, the picture link generation module 206 creates the picture link so that when the picture link is selected, a client computing device 102 is directed to the particular website.

In some embodiments, the picture link includes more than one image. For example, the picture link may include a collage of two or more images that are organized based on user input or automatically organized by the picture link generation module 206.

In some embodiments, the text generation module 208 overlays text on top of the picture link. As will be described in further detail herein, the user may add text to the picture link to provide further context to the link itself. Such text may be added through the application 104 executing on the client computing device 102. In some embodiments, the user provides text in the application 104 as part of the initial request to generate the picture image, and in other embodiments, the user may edit the picture image to include text after the picture image has been generated.

In some examples, the text can include other rich text aspects, such as emojis, images, artwork, illustrations, etc. In some examples, the text can be infused with such aspects as brand identity (e.g., color and/or images), logos, and/or other custom visual elements. These rich text aspects can be modified by the user to capture a desired effect.

Thus, the text generation module 208 may obtain text from the application 104 and overlay the text on top of the image of the picture link. In some embodiments, the text generation module 208 adjusts the color and font of the text based on the image. For example, if the image is busy or dark, the text generation module 208 may adjust the font to a lighter color and a bold font to that the text is easily viewable as it is positioned over the picture link.

In some embodiments, the text generation module 208 analyzes text from the HTML content obtained from the fetcher module 202 and parses the content to extract written text. In some embodiments, keywords may be identified and stored in the database (e.g., database 110). In some embodiments, the text generation module 208 may provide example text to the user so that the user may select one or more text phrases or words to optionally add as an overlay to the picture link.

Thus, the generated picture link may include one or more images as well as text, wherein the picture link is in a predefined shape such as a square or rectangular shape. In some embodiments, text may be laid on top of the picture image, wherein the text is taken from the website to which the picture link is directed or the text may be added by the user. Furthermore, in some embodiments, the generated picture link may further include the title of the website.

In some embodiments, the storage module 210 stores each generated picture link, extracted image, processed image, extracted text, and user-provided text in the database 110. In some embodiments, these picture links may be reusable and shared among other users.

Accordingly, such picture links may be provided in numerous formats and shared. For example, a picture link may be provided in an email address, sent via a text message, sent over an instant message, or embedded in a website. Such picture images provide people with a preview of the content found on the website to which the picture link is directed.

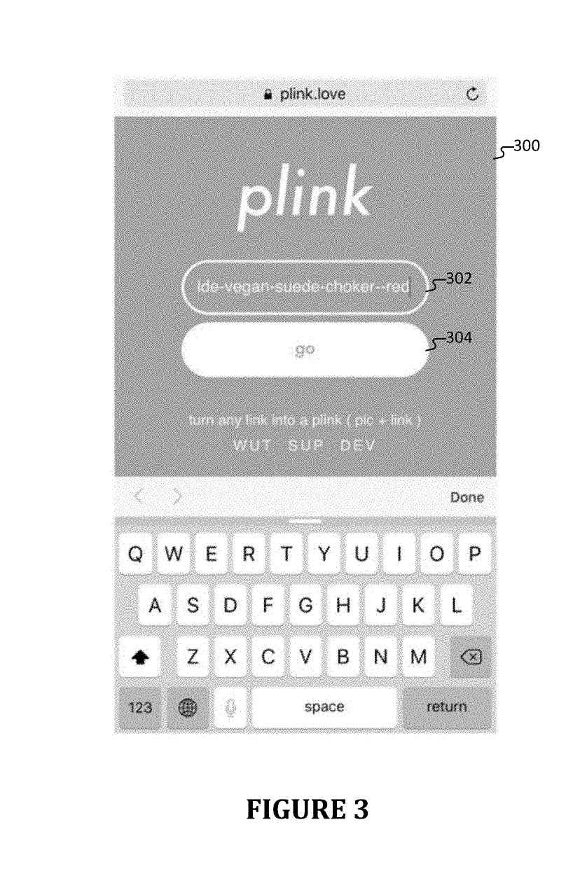

FIG. 3 illustrates a user interface 300 of the application 104 for requesting the generation of a picture link.

In particular, illustrated is an example user interface 300 of the application 104 executing on a client computing device 102. The example user interface 300 includes a text box 302 for entering in a website URL or the name of a particular website. Based on entry of such information and a selection of the go button 304, the application 104 sends a request to the link generator server 108, as described herein.

In some embodiments, the request includes the URL. Furthermore, in some embodiments, the request includes user settings such as, for example, user preferences (e.g., type of image to return in the picture link, shape of image, color of text, if any, etc.). Yet in other embodiments, the request may also include a reference to a particular image that would be used in the picture link.

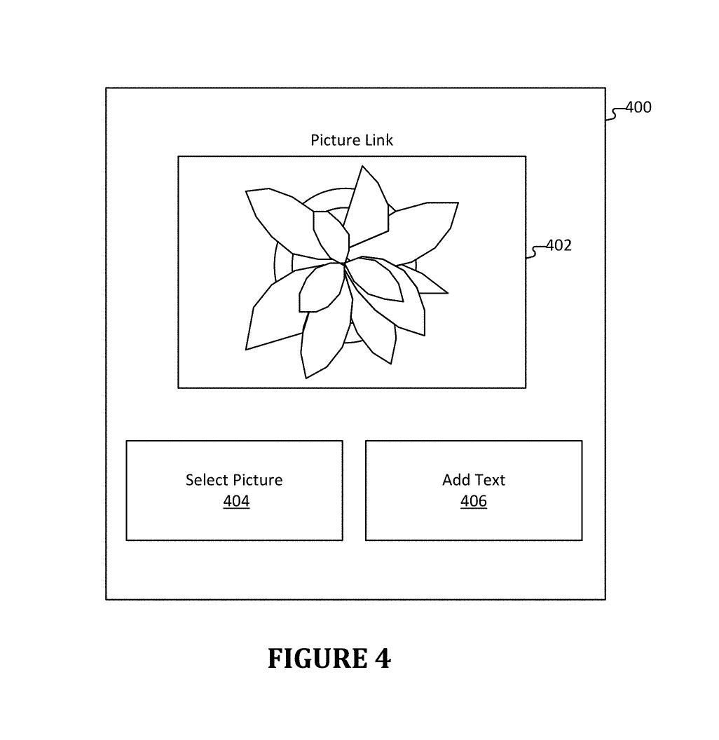

FIG. 4 illustrates an edit user interface 400 of the application 104 for editing a picture link.

As described herein, an application 104 executing on a client computing device 102 may be used to request the generation of a picture link from a link generator server 108 over a network 112. As described herein, the link generator server 108 may obtain link information from a third party server 106 to generate the picture link and send that picture link to the client device over the network 112.

In some embodiments, the application 104 may enable the user to edit the generated picture link. In some embodiments, editing the picture link may include changing the image of the picture link, or adding or editing text positioned on the picture link.

In this example, the edit user interface 400 includes the picture link generated by the link generator server 108, an option 404 to select a different picture for the picture link and an option 406 to add text to the picture link.

In some embodiments, selection of the option 404 to select a different picture opens a folder that includes one or more alternative or additional images that the user may select. As described herein, the images may be images extracted from the website and saved in the database 110. The user may select one image or multiple images. In some embodiments, if multiple images are selected, another user interface may be provided to allow the user to format the picture link having multiple images (e.g., allowing the user to format a collage of multiple images.). Additionally or alternatively, the edit user interface 400 may allow the user to select an image by simply selecting a right, left, up, or down arrow that, when selected, causes the image to update.

In some embodiments, selection of the option 406 to add text to the picture link may cause the application to provide an alternative text display that allows the user to add text to the picture link. In some embodiments, the text display may include options to select the text style, font, and color. Furthermore, the text display may allow the user to set the placement of the text over the picture link (e.g., at the top, middle bottom, diagonally over the picture image).

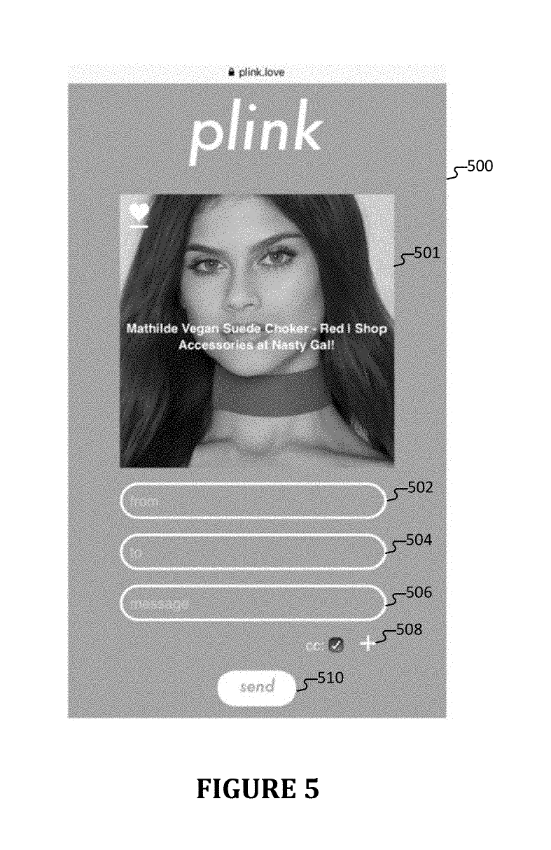

FIG. 5 illustrates a share user interface 500 of the application 104 for sharing the picture link.

As described herein, the picture link may be provided in numerous formats and shared. For example, a picture link may be provided in an email address, sent via a text message, sent over an instant message, or embedded in a website. Such picture images provide people with a preview of the content found on the website to which the picture link is directed.

In this example, the share user interface 500 of the application 104 includes a preview 501 of the picture link, a from field 502, a to field 504, a message field 506, a copy option 508, and a send button 510.

The preview 501 provides an illustration of the picture link as it would be displayed once embedded in content, such as an email address, sent via a text message, sent over an instant message, or embedded in a website. The preview 501 displays the selected image and any text placed upon that image. Should the user wish to make changes to the picture link, the user can access

The from field 502 allows the user to provide one or more email addresses or phone numbers of people to whom the picture link is to be sent. The to field 504 allows the user to provide his or her name, username, email address, or phone number so that the recipient can recognize the user who is sending the picture link. The message field 506 allows the user to add a personalized message alongside the picture link. Furthermore, the copy option 508 allows the user to copy one or more other people to the message.

In some embodiments, the disclosed picture links are rendered as HTML/CSS snippets that can be embedded into a web browser or web kit rendering context. In such an example, text is rendered on top of the picture link using CSS. In other embodiments, picture links may be generated as .png images. In such an embodiment, the picture link is rendered in the background web kit rendering context and a .png screenshot may be generated from such a virtually rendered webpage. In such an embodiment, the resulting picture link may be a single .png image whose text is part of the image file itself

Finally, the send button 510 sends the message to the people identified therein.

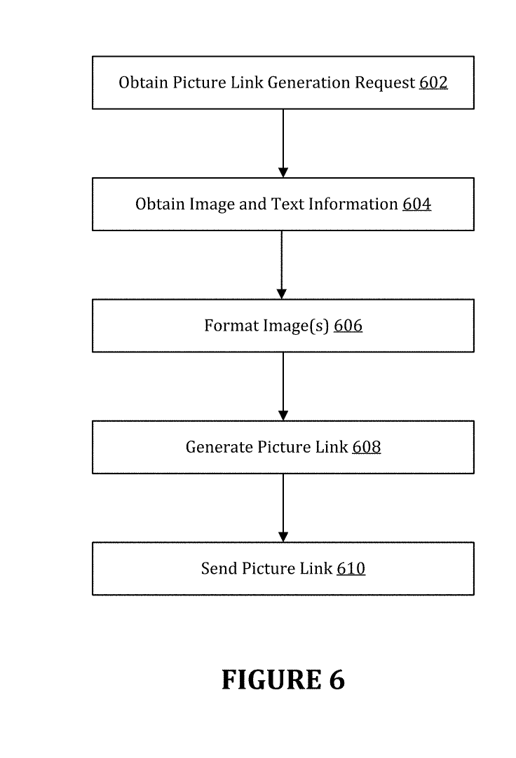

FIG. 6 illustrates a method 600 for generating a picture link, as performed by the link generator server.

In operation 602, the link generator server (e.g., link generator server 108) obtains a picture link generation request from the application (e.g., application 104) executing on a client device (e.g., client computing device 102). As described herein, the request may include a URL to a website.

In operation 604, the link generator server obtains image and text information from the website identified in the request. As described herein, the fetcher module (e.g., fetcher module 202) may request, from the third party server that hosts the website, HTML content of the website. In some embodiments, the fetcher module parses the HTML content to identify one or more image tags and for each image tag, the fetcher module may extract the corresponding image.

In operation 606, the link generator server may format the one or more images received in operation 604. In some embodiments, the image formatting module (e.g., image formatting module 204) may inspect each extracted image to identify the image width, height, format, and color diversity. The image formatting module 204 may further rank the images in order to create an order of priority. In some embodiments, higher the color diversity or the more pixelated the image will correspond to a higher image ranking.

In operation 608, the link generator server may generate the picture link. In some embodiments, the picture link generation module (e.g., picture link generation module 206) may automatically crop a selected picture or multiple pictures and link the one or more pictures to the particular website. Accordingly, the picture link generation module creates the picture link so that when the picture link is selected, a client device is directed to the particular website.

In operation 610, the link generator server may send the picture link to the client device. In some embodiments, the picture link is sent to the application executing thereon.

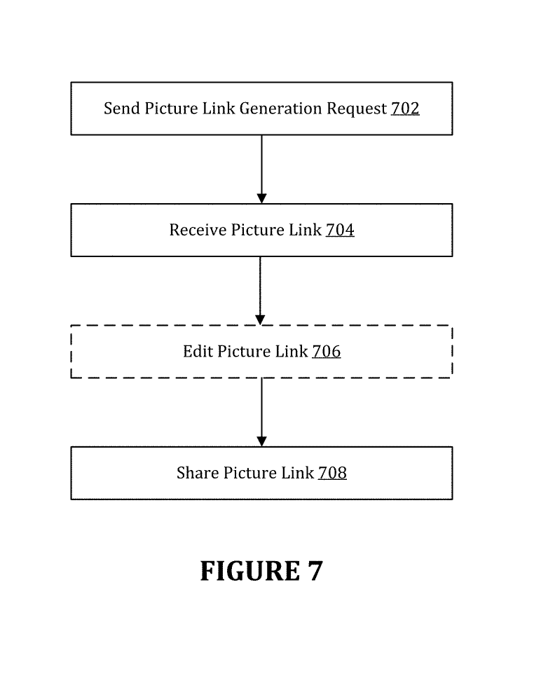

FIG. 7 illustrates a method 700 for requesting and editing a picture link, as performed by an application executing on the client device.

In operation 702, a user operating an application (e.g., application 104) executing on a client device (e.g., client computing device 102) may send a request to generate a picture link to the link generator server (e.g., link generator server 108). As described herein, the application may include a text box for providing a URL to the desired website for which the picture link would be generated. In some embodiments, the request may include a user preference as to the type of image to select.

In operation 704, the application receives the picture link from the link generator server. In some embodiments, the picture link includes one or more images, wherein those images are automatically selected by the link generator server or they may be selected based on the user's preference.

In optional operation 706, the application receives an option to edit the picture link. As described herein, receiving an option to edit the picture link may include an option to change the image of the picture link, or an option to add or edit text positioned on the picture link.

In operation 708, the picture link may be shared among one or more users. In some embodiments, the picture link may be provided in an email address, sent via a text message, sent over an instant message, or embedded in a website (e.g., social media, blog, etc.). Such picture images provide people with a preview of the content found on the website to which the picture link is directed.

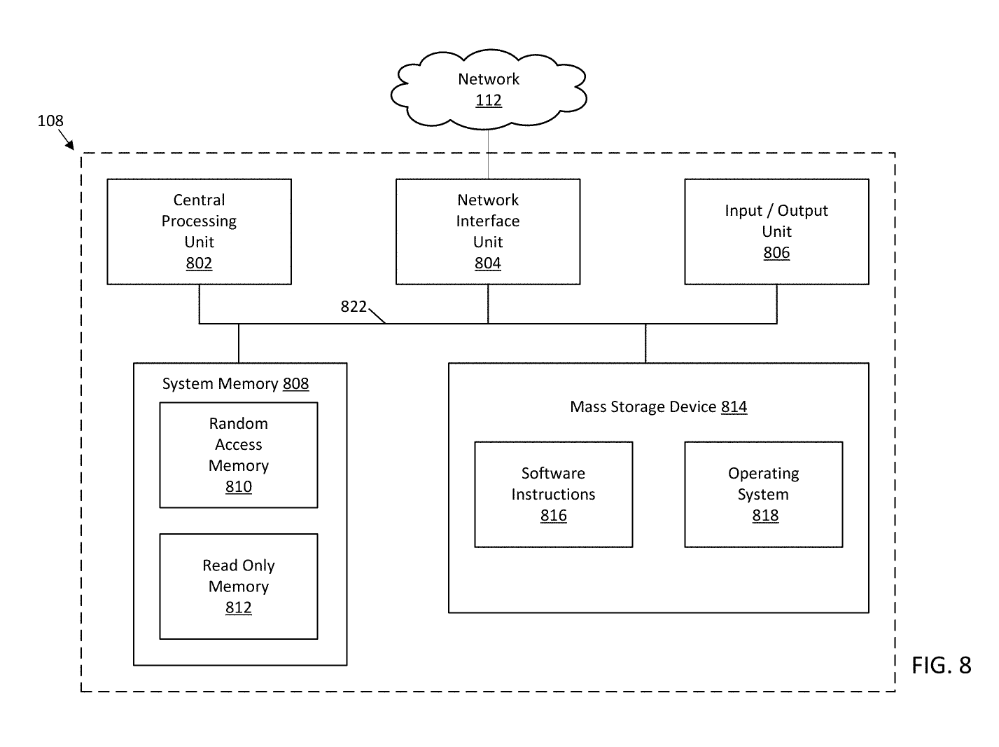

FIG. 8 illustrates example physical components of the link generator server 108 of FIG. 1. Client computing device 102 can also include any or all of the components described below.

As illustrated in the example of FIG. 8, link generator server 108 includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the link generator server 108, such as during startup, is stored in the ROM 812. The link generator server 108 further includes a mass storage device 814. The mass storage device 814 is able to store software instructions and data. Some or all of the components of the link generator server 108 can also be included in client computing device 102.

The mass storage device 814 is connected to the CPU 802 through a mass storage controller (not shown) connected to the system bus 822. The mass storage device 814 and its associated computer-readable data storage media provide non-volatile, non-transitory storage for the link generator server 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the link generator server 108.

According to various embodiments of the invention, the link generator server 108 may operate in a networked environment using logical connections to remote network devices through the network 112, such as a wireless network, the Internet, or another type of network. The link generator server 108 may connect to the network 112 through a network interface unit 804 connected to the system bus 822. It should be appreciated that the network interface unit 804 may also be utilized to connect to other types of networks and remote computing systems. The link generator server 108 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the link generator server 108 can store software instructions 816 and data. The software instructions include an operating system 818 suitable for controlling the operation of the link generator server 108. The mass storage device 814 and/or the RAM 810 also store software instructions, that when executed by the CPU 802, cause the link generator server 108 to provide the functionality of the link generator server 108 discussed in this document. For example, the mass storage device 814 and/or the RAM 810 can store software instructions that, when executed by the CPU 802, cause the link generator server 108 to display received data on the display screen of the link generator server 108.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for generating a picture link using a link generator server computer, the method comprising:
obtaining, at the link generator server computer, a request to generate the picture link, wherein the request identifies a website;
obtaining, by the link generator server computer, at least one image from the website;
formatting, by the link generator server computer, the at least one image;
allowing a user to modify the at least one image; and
generating, by the link generator server computer, the picture link using an image from the at least one image.

2. The method of claim 1, further comprising allowing the user to select among a plurality of images for inclusion in the picture link.

3. The method of claim 1, further comprising allowing the user to add text to the picture link, the text being placed over the at least one image in the picture link.

4. The method of claim 1, further comprising allowing the user modify text associated with the picture link.

5. The method of claim 1, further comprising:
parsing the website;
extracting text from the website; and
suggesting the text to the user for inclusion in the picture link.

6. The method of claim 1, further comprising:
parsing one or more tags associated with the website; and
selecting the at least one image based upon the one or more tags.

7. The method of claim 6, wherein the selecting of the at least one image further comprising selecting the at least one image based upon the user's preferences.

8. The method of claim 1, further comprising allowing the user to other rich text aspects to the picture link.

9. The method of claim 1, further comprising storing the at least one image.

10. The method of claim 1, further comprising allowing the user to select among a plurality of images from the website.

11. The method of claim 1, further comprising allowing the user to share the picture link.

12. The method of claim 11, further comprising allowing the user to share the picture link through email, text message, or instant message.

13. The method of claim 11, further comprising allowing the user to embed the picture link in a site.

14. A method for generating a picture link, the method comprising:
obtaining, at the link generator server computer, a request to generate the picture link, wherein the request identifies a website;
parsing one or more tags associated with the website; and
selecting at least one image based upon the one or more tags.
obtaining, by the link generator server computer, the at least one image from the website;
formatting, by the link generator server computer, the at least one image;
allowing the user to select among a plurality of images for inclusion in the picture link;
allowing a user to modify the at least one image; and
generating, by the link generator server computer, the picture link using an image from the at least one image.

15. The method of claim 14, further comprising allowing the user to add text to the picture link, the text being placed over the at least one image in the picture link.

16. The method of claim 14, further comprising:
parsing the website;
extracting text from the website; and
suggesting the text to the user for inclusion in the picture link.

17. The method of claim 14, wherein the selecting of the at least one image further comprising selecting the at least one image based upon the user's preferences.

18. The method of claim 14, further comprising allowing the user to other rich text aspects to the picture link.

19. The method of claim 14, further comprising allowing the user to select among a plurality of images from the website.

20. A system for generating a picture link, the system comprising:
a processor; and
memory encoding instructions which, when executed by the processor, cause the processor to:
obtain a request to generate the picture link, wherein the request identifies a web site;
obtain at least one image from the website;
format the at least one image;
allow a user to modify the at least one image; and
generate the picture link using an image from the at least one image.
